(19) United States
(12) Patent Application Publication
(10) Pub. No.: US 2003/0080982 A1
(43) Pub. Date: May 1, 2003

(54) System for, and method of, displaying gray scale images in a display monitor

(76) Inventors: Peter Steven, Cambridge, MA (US); Marlin E. Cobb, Bolton, MA (US); John P. Beck, Tyngsborough, MA (US)

Correspondence Address: ELLSWORTH R. ROSTON, ESQ., FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/046,399

(22) Filed: Oct. 29, 2001

(51) Int. Cl. G09G 5/10

(52) U.S. Cl. 345/690

(57) ABSTRACT

Groups (e.g. 3) of parallel digital video input signals having a first frequency are provided, each group having a first number (e.g. 8) of binary bits. The parallel signals in each group correspond in gray scale to the signals providing one of the colors in a single color pixel. The parallel signals may have a first particular frequency. The parallel digital signals are serialized at a second frequency constituting an integral multiple (e.g. 3) of the frequency of the parallel signals. The serialized signals are converted in a look-up table to serialized signals having the second frequency. The number of bits in each group of the signals from the look-up table have an arbitrary relationship to the number of the binary bits in each group introduced to the look-up table. For example, the number of binary bits in each group from the look-up table may be ten (10). The signals from the look-up table are converted to analog signals which produce a gray scale image on a monitor face. The monitor may be a cathode ray tube or a flat panel display. When the monitor is a flat panel display, it is formed without a color filter to increase its light intensity and to provide a gray scale image. The second frequency of the analog signals is increased (as by a FIFO) by a factor (e.g. approximately 25%) to a third frequency to compensate for the absence of a retrace for the signals in the flat panel display. This enhances the image which is produced on the flat panel display.

This invention relates to systems for, and methods of, displaying a gray scale image on a monitor which may be a cathode ray tube or a flat panel display. The invention particularly relates to systems for, and methods of, providing signals for introduction to the flat panel display which is included in one preferred embodiment of the invention. The system may be constructed in one embodiment to provide color images but may be modified to provide gray scale images such as represented by the system and method.

### BACKGROUND OF THE PREFERRED EMBODIMENT OF THE INVENTION

X-ray images are generally provided on a gray scale basis. For example, a chest x-ray to determine a cancer or an x-ray to determine a fracture of a bone is generally provide as a black-and-white image. It is desirable to enhance the resolution of the image by providing sharpened contrasts between black and white and different shades of gray. An enhanced resolution of an image may allow a physician studying the image to see problems (e.g. cancers and bone fractures) that the physician would not see if the image did not have the enhanced resolution.

There are disadvantages with the systems now in use for providing x-ray images. For example, it is sometimes desired to emphasize a particular portion of a gray scale image in relation to other portions of the gray scale image. As a particular illustration, it may be desired to emphasize a portion of a chest x-ray where there appears to be a cancer. The systems now in use have not emphasized portions of an x-ray image effectively until very recently.

The systems now in use have employed cathode ray tubes to show a gray scale image. Such systems have had a limited number of advantages and several significant disadvantages. An advantage is that the system provides a sharpened contrast between black and white when the image is viewed in a dark environment. A corollary disadvantage is that the system provided a weakened contrast between black and white and various shades of gray when the image is viewed in a light environment. Most viewers would prefer to study an x-ray image in a light environment because such an environment involves a decreased strain on the viewer's eyes, particularly when the viewers have to perform other functions such as reading books and documents between the times that the viewers study the x-ray image. The problem of viewing x-ray images in cathode ray tubes is aggravated by the fact that desired portions of the x-ray image have not been emphasized effectively in the past.

There are other disadvantages in the use of a system including a cathode ray tube to view an x-ray image. For example, the cathode ray tube in the system produces a considerable amount of heat when images are generated in the cathode ray tube. This is true even when the cathode ray tube has been activated but is not generating an image. Another disadvantage is that the cathode ray tube occupies a considerable amount of space, particularly in the depth of the cathode ray tube.

In co-pending application Ser. No. 09/659,145 filed in the United States Patent and Trademark Office (“USPTO”) on Sep. 11, 2000 and assigned of record to the assignee of record of this application and entitled SYSTEM FOR, AND METHOD OF, FORMING GRAY SCALE IMAGES IN A FLAT PANEL DISPLAY, a system and method are disclosed and claimed for using a modified color flat panel display to provide gray scale images with enhanced resolutions. For example, in the system disclosed and claimed in application Ser. No. 09/659,145, an increased number of pixel positions can be provided to obtain a gray scale image with an enhanced resolution resulting from the increased number of pixels or in which the same number of pixels can be provided in the prior art with an enhanced resolution for each of the pixels.

### BRIEF DESCRIPTION OF A PREFERRED EMBODIMENT OF THE INVENTION

In a preferred embodiment of the invention, groups of parallel digital video input signal (e.g. 3 in each group) having a first frequency are provided, each group having a first particular number (e.g. 8) of binary bits. The parallel signals in each group correspond in gray scale to the signals providing the color in a single color pixel and may have a first particular frequency. The parallel digital signals at the first frequency are serialized to provide serial signals at a second frequency substantially three (3) times the frequency of the parallel video input signals.

The serialized signals are converted in a look-up table to serialized signals having the second frequency. The signals from the look-up table may have an arbitrary relationship to the signals introduced to the look-up table. They may emphasize in the image a particular portion of the gray scale range. For example, the number of binary bits in each group may be ten (10). The signals from the look-up table are converted to analog signals which produce a gray scale image on a monitor face. The monitor may be a cathode ray tube or a flat panel display. When the monitor is a flat panel display, it is formed without a color filter to increase its light intensity and to provide a gray scale image.

When the monitor is a flat panel display, no retrace is provided such as is provided in a cathode ray tube to return the beam from an end of a line to the beginning of the next line. Since thee is no retrace in a flat panel display, the frequency of the signals may be increased (as by a FIFO) by a factor of approximately twenty-five percent (25%) to expand the signals into the time period which would be the retrace time. This enhances the image which is produced on the flat panel display.

### BRIEF DESCRIPTION OF THE DRAWINGS

In the drawings:

FIG. 1 is a schematic view, partially in section, of a flat panel display of the prior art, the flat panel display illustratively constituting an active matrix liquid crystal display;

FIG. 2 is an exploded perspective view of the prior art flat panel display shown in FIG. 1, the display including color filters for providing a color image, and also shows the percentage of the intensity of the light introduced to the flat panel display and passing through each of the successive layers or elements in the flat panel display;

FIG. 3 is a schematic perspective view showing how light is passed, or not passed, through the flat panel display of the prior art depending upon the introduction, or lack of introduction, of a control voltage to the active matrix in the display;

FIG. 4 is a view schematically showing how the light rays become twisted relative to the polarizers in the flat panel display of the prior art, the twisting of the light for each pixel being dependent upon the introduction of the control voltage to the active matrix in the display for the pixel;

FIG. 5 is a curve showing the relationship between the magnitude of the control voltage applied for each pixel to the active matrix in the flat panel display of the prior art and the intensity of the light passing through the flat panel display for the pixel;

FIG. 6 is a schematic view showing the relative sizes of the color pixels produced by the prior art flat panel display shown in FIGS. 1-4;

FIG. 7 is a view, similar to that shown in FIG. 1, of a gray scale flat panel display constituting a preferred embodiment formed by removing the color filters from, or not including the color filters in, the prior art flat panel display shown in FIGS. 1-4;

FIG. 8 is a simplified circuit diagram of the electrical circuitry for producing a scanning of the successive pixels in the flat panel display of FIG. 7 to produce a gray scale image on the face of the monitor in the flat panel display;

FIG. 9 is a schematic circuit diagram showing how voltages of different magnitudes may be provided for different portions of each pixel in a vertical direction substantially perpendicular to the horizontal direction in which the successive pixels in each row are scanned and how the voltages for the different vertical portions of each pixel may be processed, as by averaging, to obtain a median gray scale voltage for producing a gray scale image in the complete area of the pixel;

FIG. 10 shows electrical circuitry in block form for processing voltages in different portions of each gray scale pixel in the vertical direction to select a single one of the voltages, dependent upon the relative magnitudes of the voltages, for producing a gray scale image for the gray scale pixel in the flat panel display shown in FIG. 7;

FIG. 11a establishes a program for a group of pixels in the flat panel display of FIG. 7 for performing a convolution;

FIG. 11b provides data for the group of pixels for operating in conjunction with the program established in FIG. 11a to provide the convolution for the flat panel display of FIG. 7;

FIG. 12 shows electrical circuitry in block form for producing a convolution of the voltage in different portions of a group of successive gray scale pixels in the flat panel display of FIG. 7 to provide a voltage for producing a gray scale image for the group of pixels in the flat panel display (shown in FIG. 7);

FIG. 13 is a schematic diagram of an electrical system for enhancing the contrast between black images in some pixels and light images in other pixels in the flat panel display of FIG. 7 to sharpen the image on the monitor in the flat panel display;

FIG. 14 is a simplified block diagram of a prior art embodiment which includes a display such as a cathode ray tube;

FIG. 15 is a simplified block diagram of an embodiment preferably incorporating the flat panel display shown in FIG. 7 and including a look-up table for introducing voltages to the flat panel display to produce a gray scale image on the flat panel display;

FIG. 16 shows a curve providing an interrelationship between digital representations (as indicated by analog voltages) along a horizontal axis and different gray scale (or brightness) levels along a vertical axis;

FIG. 17 is a simplified block diagram of an embodiment including a flat panel display and a look-up table;

FIG. 18 is a simplified block diagram of a third (3d) embodiment also including a flat panel display and a look-up table;

FIG. 19 is a simplified block diagram of a fourth (4^{th}) embodiment including two (2) flat panel displays and two (2) look-up tables each associated with an individual one of the flat panel displays to provide a gray scale image on the individual one of the flat panel displays;

FIG. 20 is a simplified block diagram of a fifth (5^{th}) embodiment including a flat panel display and a look-up table for producing a pseudo color image in the flat panel display;

FIG. 21 is a simplified block diagram of a system constituting a first preferred embodiment of the invention and shows a system for providing a gray scale image on a monitor which may be a cathode ray tube or a flat panel display;

FIG. 22 is a simplified block diagram of a second preferred embodiment of the invention and shows a system for adapting the system in FIG. 21 to provide an enhanced gray scale image on a flat panel display; and

FIG. 23 is a schematic representation of the signals produced for a line of an image in a cathode ray tube and the retrace time for returning the beam in the cathode ray tube to the beginning of the next line in the image.

### DETAILED DESCRIPTION OF A PREFERRED EMBODIMENT OF THE INVENTION

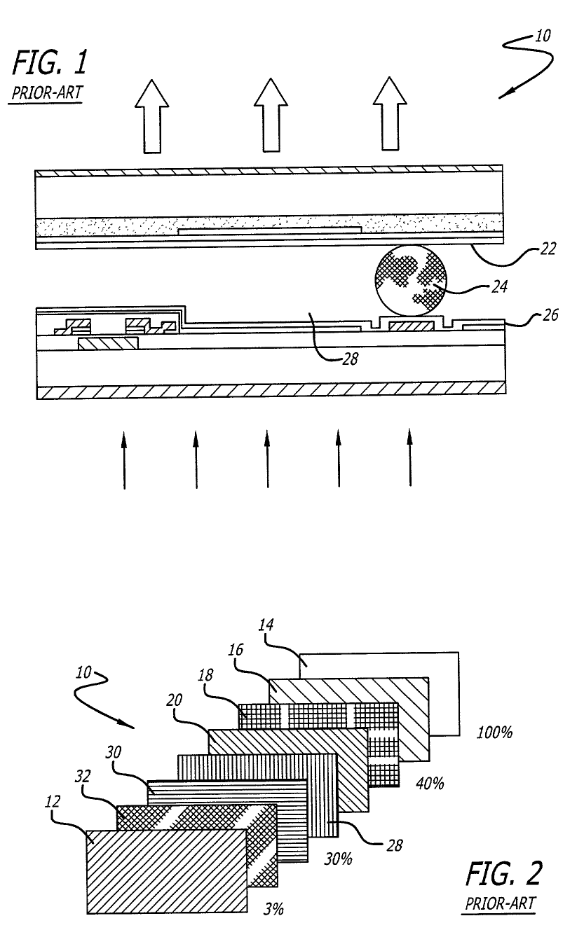

FIGS. 1-4 show a flat panel display, generally indicated at 10, for providing in the prior art a color image on a face of a polarizer 12 which may be considered to act as a display monitor. The flat panel display 10 shown in FIGS. 1-4 may constitute an active matrix liquid crystal display but a passive matrix liquid crystal display may also be used without departing from the scope of the invention. The flat panel display shown in FIGS. 1-4 is included in the prior art.

The flat panel display 10 shown in FIGS. 1-4 includes a flat layer or element 14 (FIG. 2) which passes all of the light from a light source (not shown) in back of the flat layer or element. The intensity of the light passing through the flat layer or element 14 is indicated at “100%” to the right of the flat layer 14 in FIG. 2 to indicate that all of the light introduced to the flat layer or element passes through the flat layer or element. A polarizer 16 is disposed adjacent the flat layer 14. The polarizer 16 is constructed to polarize the light in a particular direction. An active matrix 18 is disposed adjacent the polarizer 16. As will be described in detail subsequently, the active matrix 18 comprises an electrode which receives a voltage having a magnitude representing the gray scale image to be provided for each pixel in the monitor in the flat panel display 10 and which provides for the production of a gray scale image at the pixel in accordance with such voltage magnitude. The voltage for each pixel may be provided in a digital form by a particular number of binary bits. The active matrix 18 passes approximately forty percent (40%) of the light introduced to the flat panel or element 14, this percentage being produced when the active matrix 18 receives a voltage for passing a maximum amount of the light introduced to the active matrix. The indication of 40% for the passage of light through the active matrix 18 is shown to the right of the active matrix in FIG. 2.

An electrode 20 is disposed in the system 10 of the prior art adjacent the active matrix 18. The electrode 20 is provided with a reference voltage relative to a ground potential to provide a voltage reference to turn the flat panel display 10 on or off. An insulating layer 22 (FIG. 1) made from a suitable material such as a polyamide is adjacent to the electrode 20. A spacer 24 made from a suitable insulating material is disposed between the insulating layer 22 and an insulating layer 26, also made from a suitable material such as a polyamide, to provide a precise separation between the insulating layers 22 and 26. A suitable liquid crystal material 28 (FIGS. 1 and 2) is disposed in the space between the insulating layers 22 and 26. The liquid crystal material 28 preferably has anisotropic properties. An electrode 30 (FIG. 2) is disposed adjacent to the liquid crystal material 28. The electrode 30 may be made from the same material as the electrode 20 and may be provided with a reference potential such as ground. Approximately twenty percent (20%) of the intensity of the light from the layer 14 passes through the electrode 30.

Color filters 32 may be disposed adjacent the electrode 30 in the system 10 of the prior art. Three (3) filters (red, green and blue) may be provided for each pixel, generally indicated at 34 (FIG. 6), displayed on the face of the monitor in the flat panel display 10. The color filters 32 are disposed adjacent individual portions of the pixel 34 such as portions 34a, 34b and 34c in the pixel 34 in FIG. 6. The pixel portions 34a, 34b and 34c respectively provide hues of red, green and blue. The relative intensities of the color respectively provided on the pixel portions 34a, 34b and 34c of the pixel 34 determine the color or hue produced in the pixel. The light passing through the color filters 34a, 34b and 34c for each filter are introduced to the polarizer 12. Because of the operation of the color filters 32, approximately only three percent (3%) of the intensity of the light introduced to the flat panel or element 14 passes through the polarizer 12.

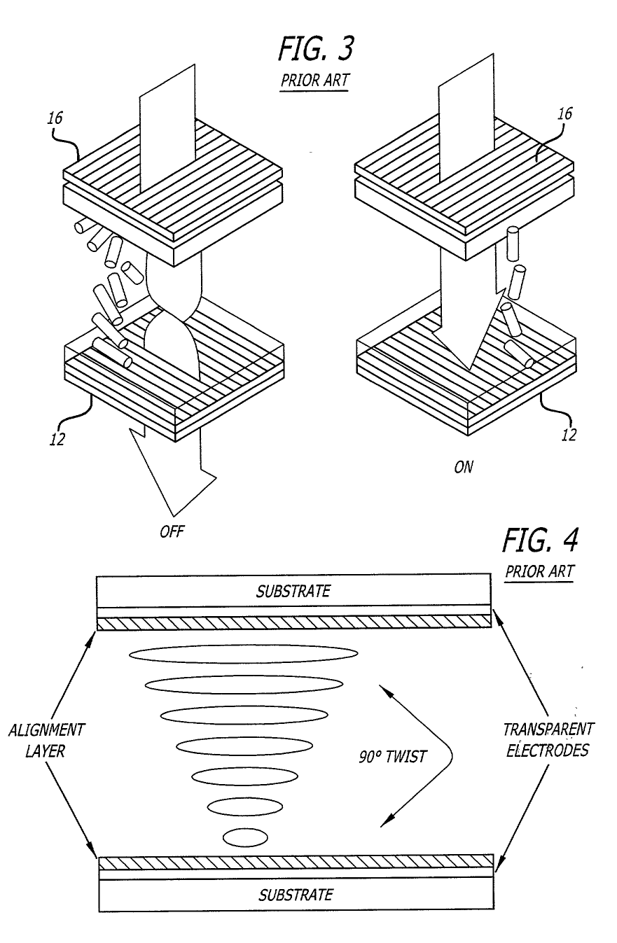

As shown schematically in FIG. 3, the polarization of the polarizer 12 in the system 10 of the prior art may be displaced by substantially 90° from the polarization of the polarizer 16 depending upon the direction in which the liquid crystal material 28 is disposed. The liquid crystal material 28 is twisted in a direction substantially perpendicular to the direction of polarization of the polarizer 12 when a reference voltage is produced between the electrodes 20 and 30 and an activating or voltage control is applied to the active matrix 18. This prevents light passing through the polarizer 16 from the flat layer 14 from passing through the polarizer 12. For any color pixel 34 where light does not pass through the polarizer 12, a black image is accordingly produced. When the reference voltage is applied between the electrodes 20 and 30 and an activating or control voltage is not applied to the active matrix 18, the polarization of the liquid crystal material 28 is not twisted so that light passing through the polarizer 16 from the flat layer or element 14 passes through the polarizer 12.

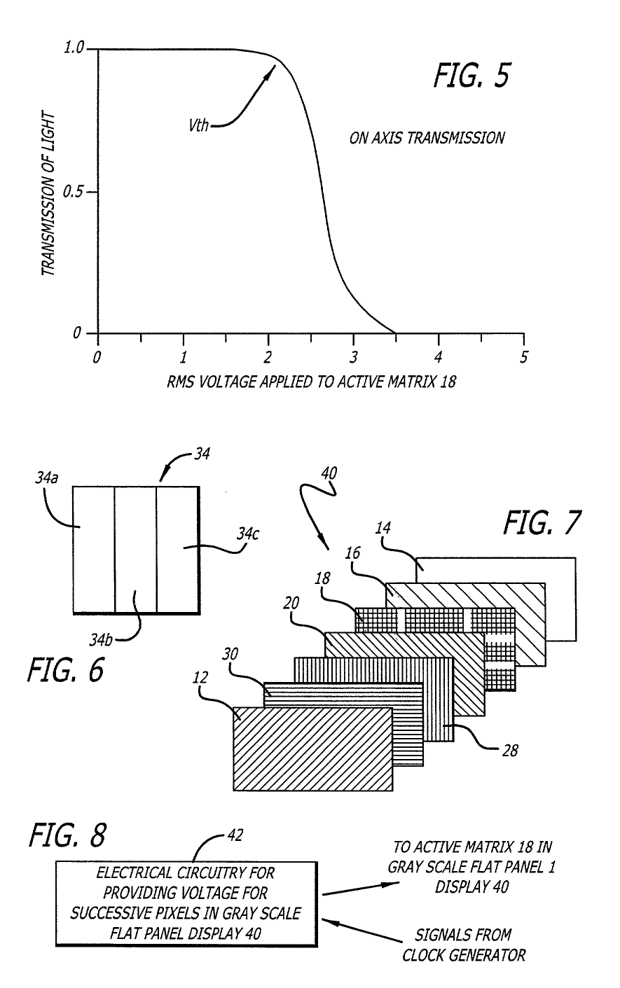

FIG. 5 is a curve illustrating the relationship between the magnitude of the voltage applied to the active matrix 18 for any pixel 34 and the intensity of the transmission of light through the polarizer 12 for that pixel in the system 10 of the prior art. As will be seen, no light passes through the polarizer 12 when a voltage equal to or greater than approximately three and one-half volts is applied to the active matrix 18. This results from the twisting of the liquid crystal material 28 as a result of the voltage applied to the active matrix 18.

On the other hand, light of a maximum intensity passes through the polarizer 12 in the system 10 of the prior art when no voltage or a voltage less than approximately one and one-half volts (1.5 v) is applied to the active matrix 18. This results from the fact that the liquid crystal material 28 is not twisted. For voltages applied to the active matrix 18 between approximately one and one-half volts (1.5V) and approximately three and one-half volts (3.5V) for any pixel 34, an image of a reduced intensity will be produced. The reduction in the intensity of the image is dependent upon the magnitude of the voltage applied to the active matrix 18 between approximately one and one-half volts (1.5V) and approximately three and one-half volts (3.5V).

FIG. 7 illustrates a flat panel display, generally indicated at 40, constituting a preferred embodiment of a system disclosed and claimed in application Ser. No. 09/659,145 (attorney file DOME-55267) filed in the United States Patent and Trademark Office on Sep. 11, 2000 and assigned of record to the assignee of record of this application. The preferred embodiment 40 is constructed to provide a gray scale image on the face of the monitor in the flat panel display. The preferred embodiment 40 is similar to the prior art embodiment 10 shown in FIGS. 1-4 except that the color filters 32 are removed or never included. By removing or never including the color filters 32, each pixel 34 is separated into three (3) pixels 34a, 34b and 34c. Each of the pixels 34a, 34b and 34c is independent in the gray scale from the other ones of the pixels 34a, 34b and 34c. Each of the pixels 34a, 34b and 34c is accordingly able to receive a voltage independent of the voltages applied to the other ones of the pixels 34a, 34b and 34c and to provide a gray scale indication representative of the applied voltage and independent of the gray scale indications provided by the other ones of the gray scale pixels 34a, 34b and 34c.

As will be seen, the pixels 34a, 34b and 34c are disposed at progressive positions in the horizontal direction in the system disclosed and claimed in application Ser. No. 09/659,145. This causes the number of pixels in each row on the face of the monitor in the flat panel display 40 to be tripled relative to the number of pixels in each row in the flat panel display 10 of the prior art and relative to the number of pixels in each row in a cathode ray tube of the prior art. This enhances the resolution of the gray scale image in the flat panel display 40 in comparison to the resolution which can be obtained if the number of pixels in each row in the gray scale image corresponded to the number of pixels in each row in the flat panel display 10 providing a color image in the prior art. It also enhances the resolution of the image relative to the resolution provided by a cathode ray tube in the prior art.

There are other significant advantages to the embodiment shown in FIG. 7 and disclosed and claimed in application Ser. No. 09/649,145. This results from the fact that the color filters 32 in the embodiment 10 shown in FIGS. 1-4 cause approximately seventeen percent (17%) of the light intensity introduced to the flat panel or element 14 to be lost. By removing or not including the color filters 32 in the gray scale embodiment shown in FIG. 7, the intensity of the light passing through the polarizer 12 increases from approximately three percent (3%) of the light intensity introduced to the flat panel or element 14 to approximately twenty percent (20%) of the light intensity introduced to the flat panel or element 14. This is almost a six (6)-fold increase in the intensity of the light passing through the polarizer 12 for the gray scale embodiment shown in FIG. 7 in comparison to the intensity of the light passing through the polarizer 12 in the color embodiment shown in FIGS. 1-4.

The enhancement in the intensity of the light passing through the polarizer 12 in the gray scale embodiment 40 shown in FIG. 7 and disclosed and claimed in application Ser. No. 09/649,145 provides other advantages in addition to those described above. For example, the enhancement in the intensity of the light passing through the polarizer 12 in the gray scale embodiment 40 causes an enhanced contrast to be produced between a black image in one of the pixels 34a, 34b and 34c and a light image in another one of the pixels 34a, 34b and 34c. Furthermore, it provides for a disposition of the flat panel display 40 in a light environment such as a brightly lit room. The disposition of the gray scale flat panel display 40 in a brightly lit environment provides for the operability of the display in a broadened range of applications in a hospital. For example, the embodiment 40 can be operated in a central area in a ward in a hospital where all of the nurses in the ward are located and where the central area has to be well lit so that the nurses can maintain, update and read records relating to the patients in the ward.

The operability of the preferred embodiment 40 in a brightly lit environment in the system disclosed and claimed in application Ser. No. 09/659,145 is in contrast to an optimal operation of a cathode ray tube system of the prior art in a dimly lit environment. An operation of the prior art cathode ray tube embodiment in a dimly lit environment is disadvantageous, particularly when the viewer has to read documents between the times that the viewer looks at the image on the face of the cathode ray tube.

Electrical circuitry 42 is schematically shown in FIG. 8 for introducing voltages representing gray scale images to the successive pixels 34a, 34b and 34c in each horizontal line in the monitor in the flat panel display 40 shown in FIG. 7 and disclosed and claimed in application Ser. No. 09/649,145. The electrical circuitry 42 may be similar to that provided for the color image on the face of the monitor in the flat panel display 10 in FIGS. 1-4 except that it occurs at a frequency three (3) times as great as the frequency of the voltages introduced to the flat panel display 10. This results from the fact that each pixel 34 in the flat panel display 10 in FIGS. 1-4 is now divided into the individual pixels 34a, 34b and 34c in the flat panel display 40 in FIG. 7. The voltages from the electrical circuitry 42 may be introduced to a line 44 which is connected to the active matrix 18 in the flat panel display 40. The introduction of the voltages to the active matrix 18 in the flat panel display 40 may be synchronized with the production on the line 44 of clock signals from a clock generator.

As will be appreciated, since the pixel 34 is substantially square in the system disclosed and claimed in application Ser. No. 09/659,145, the height of each of the pixels 34a, 34b and 34c is now three (3) times greater than the width of each of the pixels. Separate voltages may be provided for each progressive one-third (⅓) of the vertical distance of each of the pixels 34a, 34b and 34c. These voltages may be processed in different ways to provide a single individual voltage for each of the pixels 34a, 34b and 34c or a single individual voltage for a group constituting the pixels 34a, 34b and 34c. Processing the different voltages in the vertical direction for each of the pixels 34a, 34b and 34c offers certain advantages which will be described subsequently for each of a plurality of the different processing techniques.

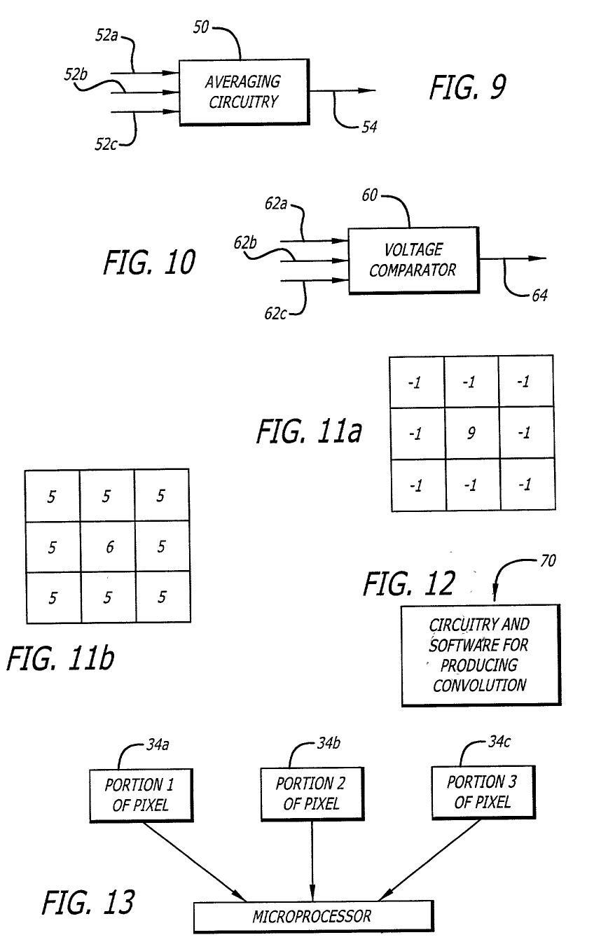

One way of processing the plurality of voltages for the different portions of each of the pixels 34a, 34b and 34c in the vertical direction in the system disclosed and claimed in application Ser. No. 09/659,145 is to average each of the plurality of voltages produced in the vertical direction for the pixel. For example, the three (3) voltages in the vertical direction for the pixel 34a may be averaged. This averaging provides for the production of a single voltage for the pixel 34a. The averaging may be processed by averaging circuitry 50 in FIG. 9. The averaging circuitry 50 receives voltages on three (3) input lines 52a, 52b and 52c for each gray scale pixel such as the pixel 34a. The voltages on the lines 52a, 52b and 52c represent gray scale images at different portions of each pixel, such as the pixel 34a, in the vertical direction. The averaged voltage produced by the circuitry 50 is provided on a line 54 at the output of the circuitry.

The production of a single averaged voltage for each pixel in the system disclosed and claimed in application Ser. No. 09/659,145 is advantageous because it provides a median gray scale value for the different portions of the pixel 34a in the vertical direction. Such averaging circuitry is known in the prior art for different applications than gray scale representations for the different pixels in a gray scale flat panel display. It is believed that a person of ordinary skill in the art will be able to apply such averaging circuits to average the pixel values in a gray scale flat panel display. Another way of processing the plurality of voltages for the different portions of each of the pixels 34a, 34b and 34c in the vertical direction in the system disclosed and claimed in application Ser. No. 09/659,145 is to select the voltage with an extreme magnitude in the plurality of voltages in the vertical direction for each of the pixels. For example, the voltage with the lowest value may be selected from the plurality of voltages for the different portions of the pixel 34a in the vertical direction. This voltage is then applied to the complete area of the pixel 34a. This provides for a brightening of the image produced on the face of the monitor in the flat panel display 40 while still providing a contrast between successive pixels. Alternatively, the voltage with the highest magnitude may be selected from the plurality of voltages for the different positions of the pixel 34a in the vertical direction. This voltage is then applied to the complete area of the pixel 34a. This will tend to darken the gray scale image displayed on the face of the monitor in the flat panel display 40 while still providing a contrast between successive pixels.

The selection of the voltage with the extreme magnitude from the plurality of the voltages for the different portions of each pixel in the vertical direction in the system disclosed and claimed in application Ser. No. 09/659,145 may be provided by a voltage comparator 60 in FIG. 10. Such a comparator is known to persons of ordinary skill in the art for other applications. It is believed that a person of ordinary skill in the art will be able to apply such a comparator to determine the extreme voltage among the voltages applied to the different vertical portions of the pixel. The comparator 60 receives voltages on input lines 62a, 62b and 62c for the different portions in the vertical direction of each pixel such as the pixel 34a. The comparator 60 compares the magnitudes of the different voltages for each pixel and selects one of the voltages depending upon its magnitude relative to the magnitudes of the other voltages for the pixel. The selected voltage is provided on an output line 64 from the comparator 60.

A third way of processing the voltages for the different portions of each of the pixels 34a, 34b and 34c in the vertical direction in the system disclosed and claimed in application Ser. No. 09/659,145 is to process the voltages in a form of a convolution. It will be appreciated that many forms of convolutions may be known to a person of ordinary skill in the art. Because of this, it is believed that one example of a convolution should be sufficient to establish the concept and practice of performing a convolution in selecting values for each of the pixels 34a, 34b and 34c. This example is shown in FIGS. 11a and 11b. FIG. 11a establishes a program for providing a convolution. FIG. 11b provides data for the different portions of each of the pixels 34a, 34b and 34c in the vertical direction. The central value “6” in FIG. 11b is multiplied by the central value “9” in FIG. 11a to give an intermediate value of 54. The values in FIG. 11b (except for the central value “6”) are summed to give a value of 40. The value of 40 is then subtracted from the value of 54 to provide a value of 14. The value of 14 indicates the gray scale to be provided for the area defined by the pixels 34a, 34b and 34c on the face of the monitor in the flat panel display 40. The convolution is provided by convoluting circuitry and software generally indicated at 70 in FIG. 12 and known in the prior art. As previously indicated, each pixel has three (3) portions 34a, 34b and 34c (FIG. 6) each of which would provide one of the red, green and blue hues if the pixel were providing color. Each portion is defined by a digital representation having a particular number of binary bits. This particular number may illustratively be eight (8). When eight (8) binary bits are provided in each of the pixel portions 34a, 34b and 34c, the binary bits in each portion can represent values between “1” and “256”.

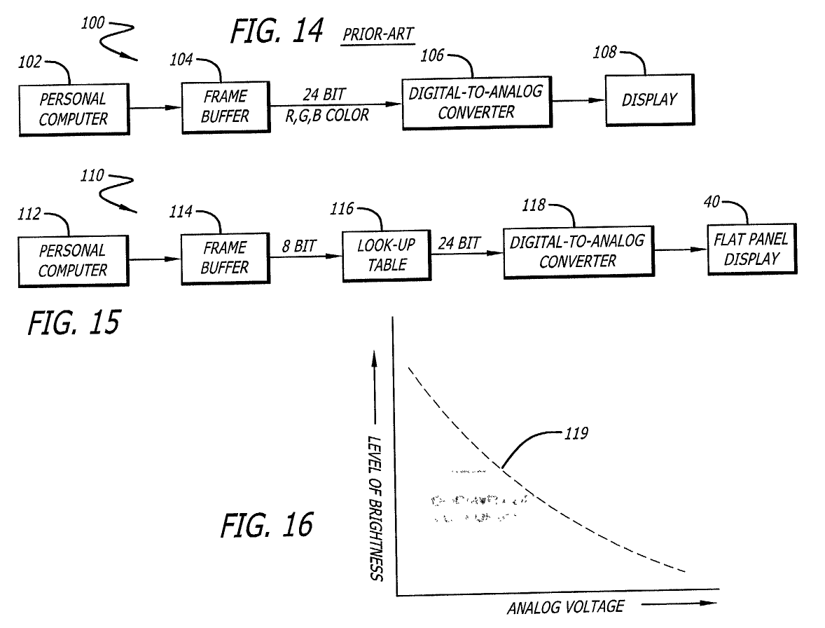

FIG. 14 provides a simplified block diagram, generally indicated at 100, of a system in the prior art for providing a display of an image in a display monitor. As shown, the system 100 includes a microprocessor such as a personal computer 102. The computer 102 introduces successive pluralities of binary bits indicative of color to a frame buffer 104 which receives and stores the successive pluralities of binary bits. For example, each plurality may include eight (8) binary bits and may indicate one of three (3) primary hues, namely red, green and blue. Each plurality of binary bits may alternatively indicate a gray scale value for a pixel to be displayed on a monitor in a panel display. The pluralities of binary bits are converted by a converter 106 to analog voltages indicative of the pluralities of binary bits. The analog voltages from the converter 106 are introduced to a display 108 such as a cathode ray tube to provide a color dependent upon the value represented by each individual one of the pluralities of binary bits. Alternatively, the analog voltages may provide a gray scale image on the display 108.

FIG. 15 shows a preferred embodiment, generally indicated at 110, of the system in application Ser. No. 09/659,145 for use with the flat panel display 40. The system 110 includes a microprocessor such as a personal computer 112 corresponding to the personal computer 102 in FIG. 14. The pluralities of binary indications from the personal computer 112 are introduced to a frame buffer 114 corresponding to the frame buffer 104 in FIG. 14. The binary indications from the frame buffer 114 in turn pass to a look-up table 116 in FIG. 15. Look-up tables such as the table 116 are known in the art but not in the combination of stages shown in FIG. 15. For example, when each plurality of binary signals has eight (8) binary bits, the look-up table 116 may have 256 positions. Each position in the look-up table 116 may provide an indication of an individual gray scale value. This value may be provided by a plurality of binary bits greater than 8. For example, each plurality of eight (8) binary bits from the frame buffer 114 may be converted to a sequence as high as twenty-four (24) binary bits in the look-up table 116.

The pluralities of the binary bits from the look-up table 116 in the system disclosed and claimed in application Ser. No. 09/659,145 are converted by a converter 118 to analog voltages indicative of the pluralities of the binary bits. The analog voltages from the converter 118 are introduced to the flat panel display 40 shown in FIG. 7. In this way, the flat panel display 40 provides an indication for each pixel with more sensitive gray scale levels than the levels indicated by the pluralities of eight (8) binary bits from the frame buffer 114. Furthermore, different relationships between the different values of the pluralities of binary bits and the gray scale levels represented between white and black by such pluralities may be provided. For example, the look-up table (LUT) 116 may be used to provide a gamma correction curve representing the response of the human eye to different levels of brightness. A typical gamma correction curve is indicated at 119 in FIG. 16. In FIG. 16, progressive values of the analog voltage are indicated along the horizontal axis and progressive values of the image brightness are indicated along the vertical axis.

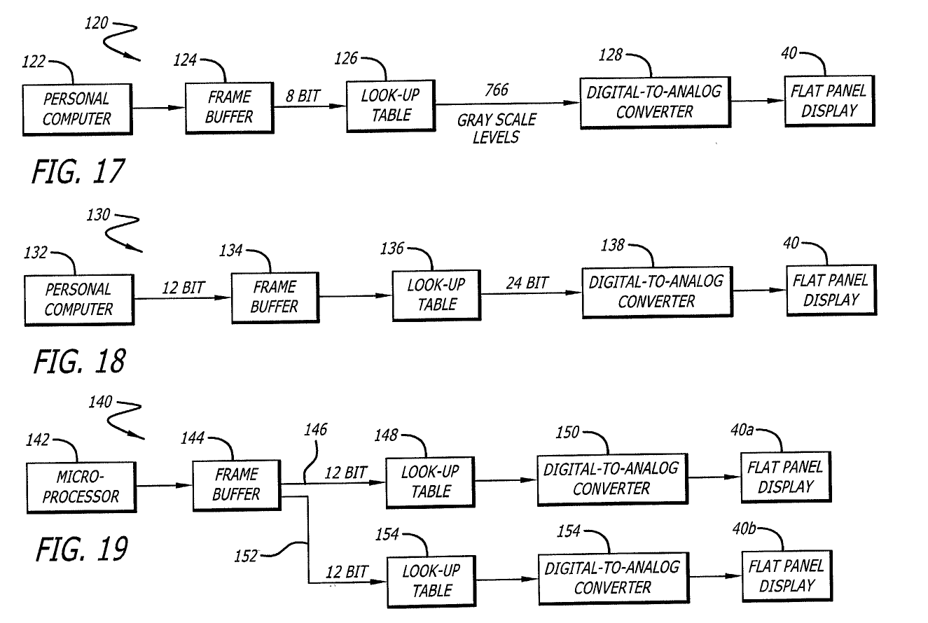

FIG. 17 shows another embodiment, generally indicated at 120, of the system disclosed and claimed in application Ser. No. 09/659,145. The embodiment shown in FIG. 17 includes a personal computer 122, a frame buffer 124 corresponding to the frame buffer 114, and a look-up table 126 for replacing the look-up table 116 in FIG. 17. The look-up table 126 receives the plurality (e.g. 8) of binary bits from each of the portions 34a, 34b and 34c in the pixel 34 and converts the combined indications from the three (3) pixel portions to 766 gray scale levels.

The personal computer 122 in the system disclosed and claimed in application Ser. No. 09/659,145 processes the binary bits from the portions 34a, 34b and 34c for each pixel 34 so that the number of available values is increased from 256 to 766. The number of available values is 3 (256)−2=766 because each of the portions 34b and 34c does not provide a value for the last digital position. From the standpoint of a log₂ analysis to determine the equivalent number of binary bits, this provides an increase in the effective number of binary bits for each pixel 34 from 2⁸ to approximately 2^{9.58} binary bits.

Since 2⁸=256, the pixel portion 34a indicates 2⁸=256 binary bits when eight (8) binary bits are provided for the pixel portion in the system disclosed and claimed in application Ser. No. 09/659,145. The pixel portion 34b provides 256 additional positions each indicating an individual value for the ninth (9^{th}) binary bit. As will be appreciated, the 9^{th} binary bit is represented by 256 binary positions. Thus, the pixel portions 34a and 34b cumulatively indicate 2⁹ binary bits. The tenth (10^{th}) binary bit is indicated by an additional 512 positions. However, the pixel portion 34c can provide only 254 positions. This is approximately 0.58 of the tenth (10^{th}) binary bit. Thus, the pixel portions 34a, 34b and 34c cumulatively indicate 2^{9.58} binary bits.

A gray scale image with a digital representation of 2^{9.58} binary bits provides a significantly enhanced contrast between different shades of gray than a gray scale image with a digital representation of only 2⁸ binary bits. Furthermore, this enhanced contrast between light pixels and dark pixels is provided in the preferred embodiment of the invention shown in FIG. 17 without changing the number of the pixels in the display monitor.

The digital representations of 2^{9.58} binary bits from the pixel portions 34a, 34b and 34c for each pixel 34 in the system disclosed and claimed in application Ser. No. 09/659,145 are converted by a digital-to-analog converter 128 to corresponding analog voltages. The analog voltage for each pixel 34 is introduced to the pixel in the flat panel display 40 to provide a gray image with a scale of enhanced sensitivity.

FIG. 18 shows another preferred embodiment, generally indicated at 130, of the system disclosed and claimed in application Ser. No. 09/659,145. The preferred embodiment 130 includes a personal computer 132, a frame buffer 134, a look-up table 136 and the flat panel display 40. The frame buffer provides twelve (12) binary bits out of the twenty-four (24) binary bits cumulatively provided by the pixel portions 34a, 34b and 34c of the pixel 34. The look-up table 136 receives the 12 binary bits from the frame buffer 134 for each pixel and converts these binary bits to digital representations for the pixel such as indicated by 24 binary bits. This enhances the contrasts between the different gray scale representations. The digital representations from the look-up table 136 for each pixel are introduced to a digital-to-analog converter 138 which produces an analog voltage indicative of the digital representations. The analog voltage causes a gray scale image to be produced on the flat panel display 40 for the pixel.

FIG. 19 provides a preferred embodiment, generally indicated at 140, which can be considered as similar to, and actually an extension of, the embodiment shown in FIG. 18 and disclosed and claimed in application Ser. No. 09/659,145. In the embodiment shown in FIG. 19, a first particular number of binary bits (e.g. 12) of the 24 binary bits cumulatively available from the pixel portions 34a, 34b and 34c of the pixel 34 are introduced by a personal computer 142 to a frame buffer 144. The binary indications from the frame buffer 144 pass through a first bus 146 to a first look-up table 148. The frame buffer 144 may correspond to the frame buffer 134 in FIG. 18 and the look-up table 148 may correspond to the look-up table 136 in FIG. 18.

The look-up table 148 in FIG. 19 may provide a conversion corresponding to the conversion discussed above in connection with the embodiment shown in FIG. 18. In other words, the look-up table 148 may convert the 12 binary bits for each pixel to a particular number such as 24 binary bits. The converted indications from the look-up table 148 are converted to analog voltages by a converter 150 and the analog voltages are is introduced to a flat panel to display 40a corresponding to the flat panel display 40 in FIG. 18 to provide an image with an enhanced gray scale resolution.

In like manner, the other 12 binary bits cumulatively provided by the frame buffer 144 for the portions 34a, 34b and 34c in each pixel 34 are introduced through a bus 152 to a look-up table 154 which may correspond to the look-up table 148. The look-up table 154 may convert the other 12 binary bits for each pixel to a particular number (e.g. 24) of binary bits. The 24 binary bits for each pixel are converted by a converter 154 to an analog voltage and the analog voltage is introduced to a flat panel display 40b corresponding to the panel 40a. The flat panel display 40b may provide an image with an enhanced gray scale resolution. In this way, the 24 binary bits cumulatively provided by the portions 34a, 34b and 34c of each pixel are converted to two (2) different digital representations for display respectively on the flat panel displays 40a and 40b.

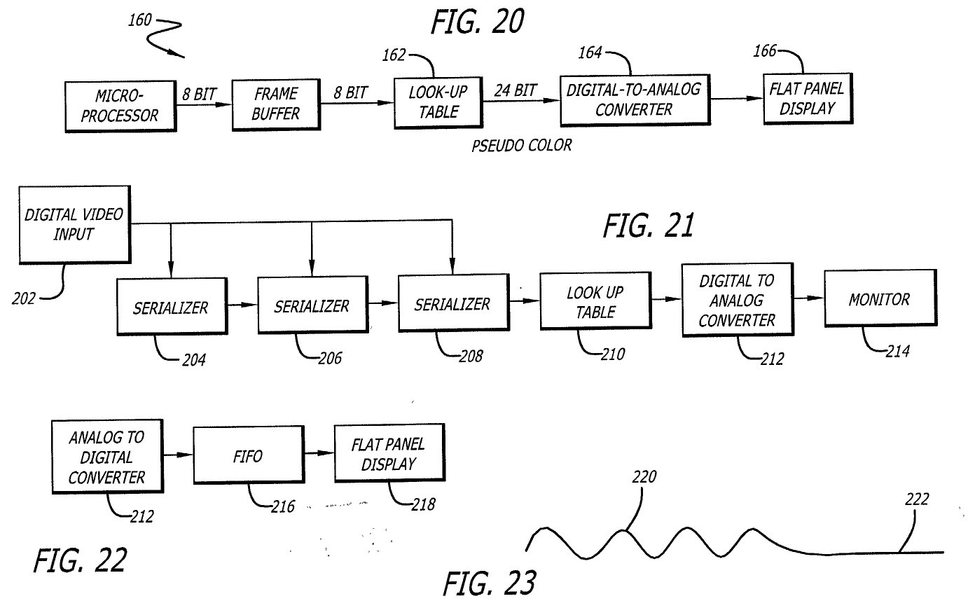

FIG. 20 provides an additional preferred embodiment, generally indicated at 160, of the system disclosed and claimed in application Ser. No. 09/659,145. In the preferred embodiment 160, a look-up table 162 may convert a particular number (e.g. 8) of binary bits in a pixel to a different number (e.g. 24) of binary bits. The binary bits (e.g. 24) from the look-up table 162 for the pixel may represent a pseudo color. These binary bits may be converted to an analog voltage by a converter 164 and the analog voltage may be introduced to a flat panel display 166 in FIG. 20 to provide an image in a pseudo color. The flat color display may include the color filters 32 in FIG. 2.

FIG. 21 schematically illustrates in block form a preferred embodiment, generally indicated at 200, of the invention. The system includes a line 202 for providing parallel signals which would represent, for a single pixel, images respectively corresponding in gray scale to what would be the colors red, green and blue if the signals were provided for a color image. Each of these signals may be considered to have eight (8) binary bits. The signals for each pixel may have twenty four (24) bits, eight (8) for each of what should be an individual one of the red, green and blue components. The signals for each pixel may be provided with a frequency of approximately one hundred and thirty five megahertz (135 MHz).

The signals on the line 202 for what would correspond to the red, green and blue components of each color pixel are divided into three (3) signals each having eight (8) binary bits in a serial stream. This is respectively indicated at stages 204, 206 and 208 in FIG. 21. The signals from the stages 204, 206 and 208 may have a frequency of approximately four hundred megahertz (400 MHz). This is approximately three (3) times the frequency of approximately one hundred and thirty five megahertz (135 MHz) constituting the frequency of the parallel signals introduced to the stages 204, 206 and 208.

The series signals in the stages 204, 206 and 208 are introduced to a look-up table 210 which converts each sequence of eight (8) binary bits into a sequence, preferably of a different number of binary bits other than eight (8). For example, the sequence of eight (8) binary bits in each of the stages 204, 206 and 208 may be converted in the look-up table into a sequence of ten (10) binary bits in each stage.

The ten (10) binary bits provided in the look-up table 210 for each of the eight (8) binary bits in each of the stages 204, 206 and 208 may have an arbitrary value different from the value represented by the eight (8) binary bits in the stages 204, 206 and 208. In this way, a particular portion of the gray scale may be emphasized. For example, the portion of the gray scale indicating bone fractures may be emphasized by the arbitrary values in the look-up table 210 to enhance the showing of the bone fractures.

The digital indications for each pixel in the look-up table 210 are introduced to a digital-to-analog converter 212 which converts the digital indications for each pixel to a corresponding analog value. The analog signals are then introduced to a display monitor 214. The display monitor 214 may be either a cathode ray tube or a flat panel display.

When the monitor 214 is a flat panel display, the signals introduced to the stages 204, 206 and 208 may be provided in the manner described above in connection with the embodiments shown in FIGS. 1-20. When the monitor 214 is a cathode ray tube, the signals provided to the stages 204, 206 and 208 may be those normally provided in the prior art for a cathode ray tube.

FIG. 22 provides a modification of the system shown in FIG. 1 and constitutes a preferred embodiment of the invention. The system shown in FIG. 22 is adapted to be used with the monitor 214 when the monitor constitutes a flat panel display. In FIG. 22, the signals from the digital-to-analog converter 212 are introduced to a first-in-first-out stage (FIFO) 216. The FIFO stage 216 converts the analog signals from a frequency of approximately four hundred megacycles (400 MHz) to a frequency of approximately five hundred megahertz (500 MHz). The increase in the frequency of the signals introduced to a flat panel display corresponding to the monitor 214 is advantageous when the monitor is a flat panel display because it enhances the resolution of the image in the flat panel display.

The increase in the frequency of the signals from the FIFO 216 compensates for the fact that there is no retrace time in a flat panel display as there is in a cathode ray tube. The retrace time is the time required for the beam in a cathode ray tube to return from the right end of each line in an image on the cathode ray tube to the left end (or beginning end) of the next line in the cathode ray tube. The may be seen from FIG. 23 where the signals in an image line in a cathode ray tube are indicated at 220 and the retrace time (where no signals are produced) for the return of the beam from the right end of each line to the left end of the next line in the cathode ray tube is indicated at 222. The increase in the frequency of the signals from the FIFO 216 compensates for the retrace time 222 in FIG. 23.

Although this invention has been disclosed and illustrated with reference to particular preferred embodiments, the principles involved are susceptible for use in numerous other embodiments which will be apparent to persons of ordinary skill in the art. The invention is, therefore, to be limited only as indicated by the scope of the appended claims.

What is claimed is:

1. A method of providing a gray scale image, including the steps of:
providing parallel digital input signals each corresponding to one of the colors red, green and blue in a single color pixel but each representing a gray scale image in a single pixel and each having a particular number of binary bits,
converting the parallel digital video input signals to series digital video input signals,
introducing the series video input digital signals to a look-up table for converting the digital video input signals to series digital signals each having a second particular number of binary bits greater than the first particular number of bits for each of the series digital input signals,
converting the series digital signals to corresponding analog signals each representative of a pixel, and
providing a display on a monitor of gray scale images having at each successive pixel a gray scale image representative of the analog signal produced at that pixel.

2. A method as set forth in claim 1 wherein
the monitor is a flat panel display not including color filters and wherein
the analog signals are increased in frequency to compensate for the lack of any retrace time for the image in the flat panel display.

3. A method as set forth in claim 2 wherein
the analog signals are introduced to a FIFO to increase the frequency of the analog signals and thereby compensate for the lack of any retrace time in the flat panel display.

4. A method of providing a gray scale image including the steps of:
providing successive groups of digital video input signals where the signals in each group correspond to the signals representing different hues in a color pixel and where the digital video input signals in each group represent successive pixels in a gray scale image and wherein the digital video input signals in each group are provided in parallel,
converting the parallel digital video input signals in each group to first series digital video input signals each having a first particular number of binary bits,
converting in a look-up table the first series digital video input signals, each having the first particular number of binary bits, to second series digital video input signals each having a second particular number of binary bits greater than the first particular number of binary bits,
converting the second series digital video inputs signals, each having the second particular number of binary bits, to corresponding analog signals, and
displaying the analog signals as gray scale images on the face of a monitor.

5. A method as set forth in claim 4 wherein
the parallel digital video input signals in each group are provided at a first frequency and wherein
the first series digital video input signals in each group are provided at a second frequency constituting an integral multiple of the first frequency and wherein
the second series video input signals in each group are provided at the second frequency.

6. A method as set forth in claim 4 wherein
each of the parallel digital video input signals in each group is provided with the first particular number of binary bits and wherein
each of the first series digital video input signals in each group is provided with the first particular number of binary bits and wherein
each of the first series digital video input signals in each group is converted in a look-up table to the second digital video input signals having the second particular number of binary bits.

7. A method as set forth in claim 5 wherein
the monitor is a flat panel display with a color filter not included in the flat panel display and wherein
the frequency of the analog signals is increased by a particular factor to compensate for the absence of a retrace time in a flat panel display.

8. A method as set forth in claim 7 wherein the increase in the frequency of the analog signals is provided by a FIFO.

9. Apparatus for providing a gray scale image, including:
a source of groups of parallel digital video input signals each having a first particular number of binary bits, the signals in each group corresponding in gray scale to the signals providing the color in a single color pixel,
a serializer of the parallel digital input signals to provide first serial digital input signals each having the first particular number of binary bits,
a look-up table for converting the first serial digital video input signals to second serial digital video input signals each having a second particular number of binary bits greater than the first particular number of binary bits,
a digital-to-analog converter for converting the second serial digital video input signals to analog signals, and
a monitor for producing a gray scale image in accordance with the analog signals from the converter.

10. Apparatus as set forth in claim 9 wherein
the parallel digital video input signals are provided at a first frequency and wherein
the serial digital video input signals are provided at a second frequency constituting an integral multiple of the first frequency.

11. Apparatus as set for the in claim 9 wherein
the monitor is a cathode ray tube.

12. Apparatus as set forth in claim 9 wherein
the monitor is a flat panel display constructed for providing a color image but with a color filter not included in the flat panel display.

13. Apparatus as set forth in claim 9 wherein
the monitor is a flat panel display constructed for providing a color image but with a color filter not included in the flat panel display thereby to provide a gay scale image and wherein
a FIFO is provided to increase the frequency of the analog signals to the third frequency from the second frequency, before introducing the analog signals to the flat panel display, to compensate for the absence of a retrace in the flat panel display.
